(19) United States
(12) Patent Application Publication
(10) Pub. No.: US 2026/0105383 A1
(43) Pub. Date: Apr. 16, 2026

(54) PREDICTION-GUIDED ENSEMBLING FOR MACHINE LEARNING MODELS

(71) Applicant: INTERNATIONAL BUSINESS MACHINES CORPORATION, ARMONK, NY (US)

(72) Inventors: James Liam Finnie, Renningen (DE); CALISTO ZUZARTE, Pickering (CA); Vincent Corvinelli, Mississauga (CA); Brandon Lewis Frendo, Markham (CA); SEYED MOHAMMAD AMIN KAMALI, Orleans (CA)

(21) Appl. No.: 18/916,819

(22) Filed: Oct. 16, 2024

(51) Int. Cl. G06N 20/20; G06N 5/04

(52) U.S. Cl. CPC G06N 20/20; G06N 5/04

(57) ABSTRACT

An approach is provided for prediction-guided machine learning model ensembling. Label groupings within an output range of a base machine learning model are determined. Accuracies of the base model across the label groupings are evaluated. One or more of the label groupings are identified whose respective evaluated accuracy does not satisfy end user-defined criteria. Using a reduced training set, a specialized machine learning model for a given label grouping included in the identified one or more label groupings is trained. A majority of samples of the reduced training set are from the given label grouping. During inference, it is determined that an initial prediction by the base model is within an output range specified by the given label grouping. A weighting for an ensembling using the base model and the specialized model is determined. Using the ensembling, the initial prediction is refined to generate a final prediction.

### BACKGROUND

The present invention relates to machine learning, and more particularly to ensembling for machine learning regression models.

### SUMMARY

In one embodiment, the present invention provides a computer-implemented method. The method includes determining label groupings within an output range of a base machine learning model. The method further includes evaluating accuracies of the base model across the label groupings. The method further includes identifying one or more of the label groupings whose respective evaluated accuracy does not satisfy end user-defined criteria specifying a closeness of predictions by the base model to expected values. The method further includes training, using a reduced training set, a specialized machine learning model for a given label grouping included in the identified one or more label groupings. A majority of samples of the reduced training set are from the given label grouping. The method further includes determining, during inference, that an initial prediction by the base model is within an output range specified by the given label grouping. The method further includes determining a weighting for an ensembling using the base model and the specialized model. The method further includes refining, using the ensembling, the initial prediction to generate a final prediction.

A computer system and a computer program product corresponding to the above-summarized computer-implemented method are also described herein.

### BRIEF DESCRIPTION OF THE DRAWINGS

FIG. 1 is a block diagram of a system for prediction-guided ensembling for machine learning models, in accordance with embodiments of the present invention.

FIG. 2 is a block diagram of modules included in code included in the system of FIG. 1, in accordance with embodiments of the present invention.

FIG. 3 is a flowchart of a process of prediction-guided ensembling for machine learning models, where operations of the flowchart are performed by modules in FIG. 2, in accordance with embodiments of the present invention.

FIG. 4 is a block diagram of components in a training part of a system that performs the operations in the flowchart of FIG. 3 that occur during training time, in accordance with embodiments of the present invention.

FIG. 5 is a block diagram of components in an inference part a system that performs the operations in the flowchart of FIG. 3 that occur during inference time, in accordance with embodiments of the present invention.

### DETAILED DESCRIPTION

### Overview

Known large machine learning regression models (or ensemble of models) can be trained to provide accurate predictions across a wide range of input values; however, model size, training time, and/or resource usage may be prohibitive. Known smaller machine learning models may train quickly and provide good accuracy for most output ranges, but may have unacceptable accuracy for some output ranges, such as for very small or very large output predictions.

Conventional ensembling techniques are used to increase model accuracy without considering the impact on overall training time, and often increase training time significantly, which is especially problematic for situations in which models are trained on an end user system and the end user requires minimal interference to running workloads on the end user system. Furthermore, some known ensembling techniques are restricted by requiring input feature analysis, where distinguishing input features are required to determine which model or tree of models will yield the most accurate prediction.

Embodiments of the present invention address the aforementioned unique challenges by (i) automatically determining label groupings within the output range of a machine learning model (also referred to herein as the base model); (ii) evaluating the base model accuracy across the label groupings to determine which, if any, label groupings have unacceptable accuracy; (iii) for a given label grouping having unacceptable accuracy, training a secondary machine learning model (i.e., specialized model) using a reduced training set that targets only a particular output range specified by the given label grouping (hereinafter, also referred to as the problematic range); (iv) subsequently, during inference time, using an initial prediction output from the base model to determine if the target is in the problematic range; and (v) if the target is in the problematic range, then using ensembling based on the trained secondary model and the base model to refine the initial prediction to generate a final prediction output. The specialized model and the base model may be different types of machine learning models. The label groupings can be sub-ranges of a range of numbers for a regression problem or sub-classes based on features or attributes for a classification problem.

Embodiments of the present invention provide a prediction-guided ensembling for a machine learning model that requires few training resources and provides sufficient accuracy across the entire output range, where the accuracy meets or exceeds a predetermined threshold measurement of accuracy, and where the accuracy meets the organizational needs of an end user. Embodiments of the present invention minimize training time while providing “good enough” accuracy for the problem domain. Additional ensemble models are trained only for the subset of the output domain that does not exhibit good enough accuracy. In one embodiment, the prediction-guided ensembling technique disclosed herein trains any secondary models only on a proper subset of the training set (i.e., those training samples whose output labels fall in an unacceptable range), thereby facilitating the minimization of total training time.

In one embodiment, the prediction-guided ensembling technique disclosed herein provides more reliable accuracy across the entire regression range (for regression models), or across all output classes (for classification models). Rather than focusing on overall accuracy, which may sacrifice one portion of the regression range, or a subset of the output classes, the prediction-guided ensembling technique disclosed herein provides good accuracy across all output ranges or classes.

In one embodiment, the technique disclosed herein minimizes inference time, because often only the base model prediction is sufficient, and additional models are used only depending on the output prediction.

In one embodiment, the technique disclosed herein is independent of input feature analysis, and therefore can be applied even if no discernible pattern in the input features can be detected, thereby making the prediction-guided ensembling technique advantageous for scenarios in which the input training data is not known a priori.

In one embodiment, the system disclosed herein facilitates an effective database machine learning optimizer (also referred to as an artificial intelligence (AI) query optimizer) that improves system performance with faster query execution time, decreased storage costs, and decreased maintenance costs. In one embodiment, minimized resource consumption during training is provided, thereby decreasing the impact on other critical workloads running on end user systems.

### Computing Environment

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer-readable storage media (also called “mediums”) collectively included in a set of one, or more, storage devices, and that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

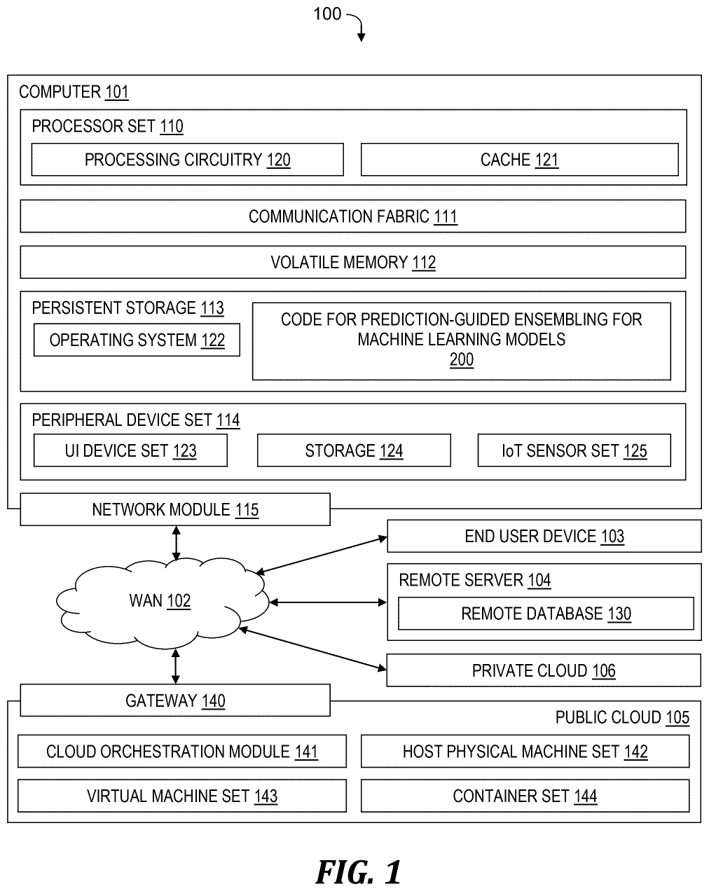

FIG. 1 is a block diagram of a system for prediction-guided ensembling for machine learning models, in accordance with embodiments of the present invention. Computing environment 100 contains an example of an environment for the execution of at least some of the computer code involved in performing the inventive methods, such as code 200 for prediction-guided ensembling for machine learning models. The aforementioned computer code is also referred to herein as computer-readable code, computer-readable program code, and machine readable code. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

### System and Process for Prediction-Guided Ensembling for Machine Learning Models

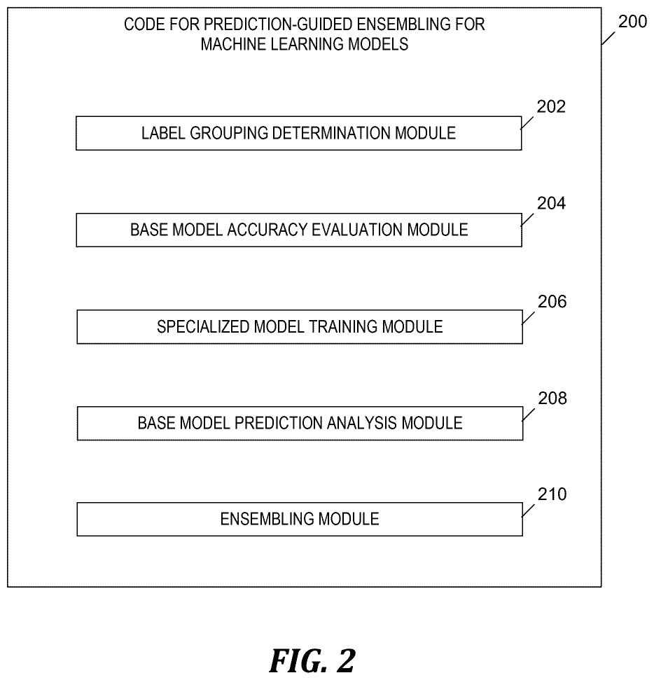

FIG. 2 is a block diagram of modules included in code included in the system of FIG. 1, in accordance with embodiments of the present invention. Code 200 includes a label grouping determination module 202, a base model accuracy evaluation module 204, a specialized model training module 206, a base model prediction analysis module 208, and an ensembling module 210.

Label grouping determination module 202 is configured to determine multiple label groupings within an output range of a base model. Label grouping determination module 202 determines the label groupings based on (i) the activation function of the base model (e.g., because sigmoid activations saturate near 0.0 and 1.0 in a 0.0 to 1.0 range, creating more label groupings at each end of the range may be desirable), (ii) sub-dividing the output range into fixed units, or (iii) any other domain-specific method of determining label groupings.

Base model accuracy evaluation module 204 is configured to evaluate base model accuracy across label groupings to determine which, if any, label groupings have an unacceptable accuracy (i.e., have an accuracy that does not satisfy end user-defined criteria specifying a closeness of base model predictions to expected values, where the criteria are based on end user requirements, and where the aforementioned closeness of the base model predictions is a relative closeness to the expected values or an exact closeness to the expected values). In one embodiment, the end user of the base model defines criteria for an unacceptable or acceptable level of accuracy for a label grouping in relative terms, such as specifying that at least X % of model predictions within a given label grouping must be within Y % of the expected value for the accuracy of the given label grouping to be acceptable (e.g., for a label grouping to have acceptable accuracy, model predictions in the label grouping must be within 10% of the expected value at least 19 times out of 20). In another embodiment, the end user of the base model defines criteria for an unacceptable or acceptable level of accuracy for a label grouping in exact terms, such as specifying that at least X % of model predictions must be within Y units of the expected value (e.g., for a label grouping to have acceptable accuracy, model predictions in the label grouping must be within 0.005 units of the expected value at least 9 times out of 10).

Specialized model training module 206 is configured to train secondary machine learning model(s) (also referred to herein as specialized model(s)) only for label grouping(s) that have an unacceptable accuracy. Specialized model training module 206 is further configured to train each of the specialized models using a reduced training set that includes samples whose output label is in the targeted grouping. Specialized training module 206 is further configured to preserve a given trained specialized model in a repository only if the label grouping prediction accuracy is improved by ensembling using the given specialized model.

Base model prediction analysis module 208 is configured to determine if any of the specialized models trained and preserved by specialized model training module 206 are suitable for ensembling by comparing an initial output prediction by the base model to the label groupings of the specialized models. An initial prediction by the base model that is included in a range indicated by a given label grouping of a specialized model indicates that the specialized model is suitable for ensembling.

Ensembling module 210 is configured to, if base model prediction analysis module 206 determines that one or more specialized models are suitable for ensembling, (i) dynamically determine weighting for ensembling based on where the initial output prediction lies with respect to each specialized model label grouping; (ii) perform ensembling using the base model, the suitable specialized model(s), and the aforementioned weighting; and (iii) use the aforementioned ensembling to refine the initial output prediction to generate and return a final prediction. Ensemble module 210 is further configured to return the initial output prediction by the base model as the final prediction, if base model prediction analysis module 206 determines that no specialized models are suitable for ensembling.

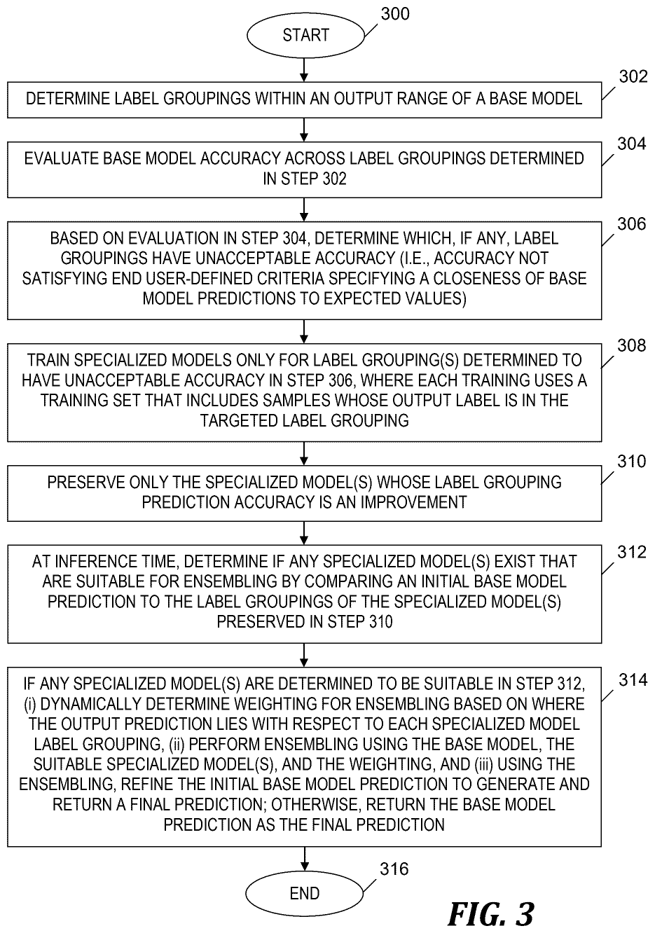

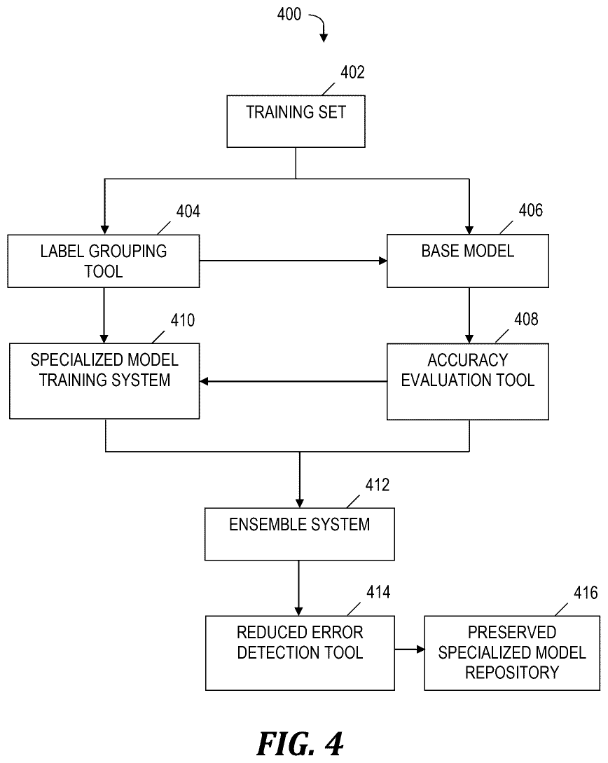

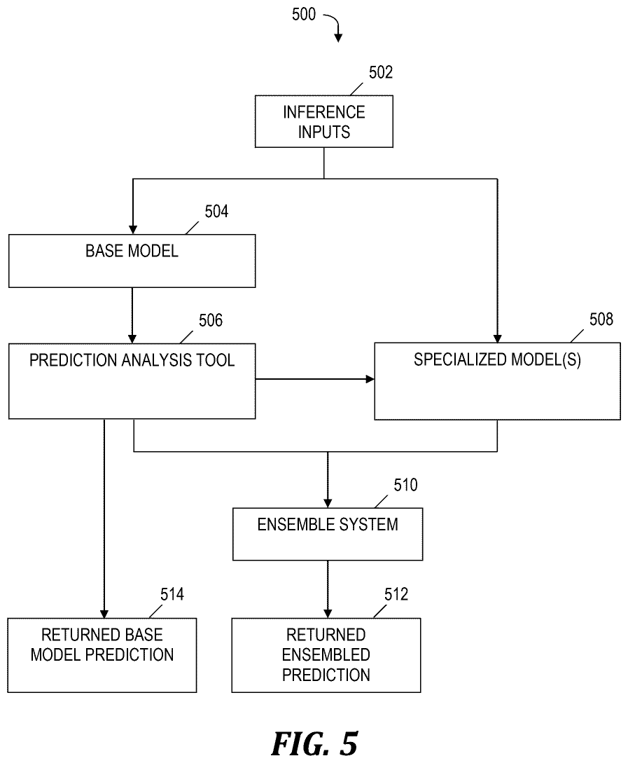

The functionality of the modules included in code 200 is described in more detail in the discussions presented below relative to FIG. 3, FIG. 4, and FIG. 5.

FIG. 3 is a flowchart of a process of prediction-guided ensembling for machine learning models, where operations of the flowchart are performed by modules in FIG. 2, in accordance with embodiments of the present invention. The process of FIG. 3 begins at a start node 300. In step 302, label grouping determination module 202 determines two or more label groupings within an output range for predictions by a base model. In one embodiment, the label groupings determined in step 302 are based on an activation function of the base model. For example, for a neural network using a sigmoid output activation function, additional label groupings are determined in step 302 for portions of an output range that are near each end of the output range because sigmoid activations saturate near those ends of the output range. In one embodiment, label groupings are determined in step 302 by sub-dividing the output range into fixed units. In other embodiments, other domain-specific methods of determining label groupings are used to determine the label groupings in step 302.

In step 304, base model accuracy evaluation module 204 evaluates the accuracy of the base model across the label groupings determined in step 302. In one embodiment, base model accuracy evaluation module 204 uses a validation set to evaluate the accuracy of the base model in step 304. The validation set includes a collection of inputs to the base model and expected labels for the inputs. The evaluation of the base model is based on a comparison between predictions made by the base model and the expected labels.

In step 306, based on the evaluation performed in step 304, base model accuracy evaluation module 204 determines which, if any, of the label groupings determined in step 302 have an unacceptable accuracy (i.e., an accuracy that does not satisfy end user-defined criteria specifying a relative closeness or an exact closeness of base model predictions to expected values, where the criteria are based on end user requirements). In one embodiment, base model accuracy evaluation module 204 identifies one or more label groupings included in the label groupings determined in step 302 as having an unacceptable accuracy.

In one embodiment, for regression problems, the determination of label groupings that have unacceptable accuracy in step 306 uses calculations of mean squared error (i.e., a difference between a prediction and an actual result). In one embodiment, instead of calculating an overall mean squared error across the entire range of all of the validation queries, label grouping determination module 202 splits up the entire range of 0.0 to 1.0 into different sub-ranges (i.e., label groupings) (e.g., split the range into the sub-ranges of 0.0 to 0.1, 0.1 to 0.2, 0.2 to 0.3, etc.) and base model accuracy evaluation module 204 calculates separate mean squared errors, respectively, for the different sub-ranges. This calculation of separate mean squared errors allows a comparison of how well the base model predicts on the various sub-ranges. A particular sub-range that has a high mean squared error (i.e., a mean squared error that exceeds a predetermined threshold amount of error), indicates that the base model performs poorly on that sub-range, which determines that a specialized model needs to be trained on that particular sub-range (as discussed below relative to step 308).

In step 308, specialized model training module 206 trains specialized models only for label grouping(s) determined to have unacceptable accuracy in step 306. Each training in step 308 of a given specialized model which has a targeted label grouping uses a training set that includes samples whose output label is in the targeted label grouping. In at least some embodiments, a majority of the samples of the specialized training set are from the given label grouping.

In step 310, base model prediction analysis module 208 preserves a given specialized model trained in step 308 only if ensembling module 210 performs ensembling using the base model and the given specialized model, which results in a prediction accuracy for the label grouping associated with the given specialized model that is improved as compared to the base model prediction accuracy evaluated in 304 for the same label grouping. The preserving of a specialized model in step 310 includes storing the specialized model in a data repository.

In one embodiment, base model accuracy evaluation module 204 calculates a mean squared error for each of the label groupings, as discussed above. For a given label grouping, ensembling module 210 uses the given specialized model trained in step 308 and the base model in an ensembling to calculate a new mean square error. If the new mean square error does not indicate an improvement over the mean square error calculated for the same label grouping with respect to the base model without ensembling, then the base model prediction analysis module 208 does not preserve the given specialized model in the data repository. Alternatively, if the new mean square error indicates an improvement over the mean square error calculated for the same label grouping with respect to the base model without ensembling, then the base model prediction analysis module 208 stores and preserves the given specialized model in the data repository.

In one embodiment, steps 302, 304, 306, 308, and 310 are performed during training time.

In step 312, base model prediction analysis module 208 determines, at inference time, whether any of the specialized model(s) that were preserved in step 310 are suitable for ensembling, where the determining is performed by comparing an initial base model prediction to the label grouping(s) of the specialized model(s) preserved in step 310. In one embodiment, step 312 includes base model prediction analysis module 208 determining that a given specialized model preserved in step 310 is suitable for ensembling by determining the initial base model prediction is included in the label grouping of the given specialized model.

In step 314, if any specialized model(s) are determined to be suitable for ensembling in step 312, then ensembling module 210 (i) dynamically determines weighting for ensembling based on where the initial base model prediction lies with respect to the label grouping(s) of the specialized model(s) determined to be suitable for ensembling; (ii) performs ensembling using the base model, the specialized model(s) determined to be suitable for ensembling in step 312, and the weighting; and (iii) using the ensembling, refining the initial base model prediction to generate and return a refined final prediction. In some embodiments for samples within a given label grouping for which a specialized model was generated, the weighting includes providing a weight of 100% for the prediction of that particular specialized model and a weight of 0% for the prediction of the base model. In some embodiments for samples within a given label grouping for which a specialized model was generated, the weighting includes providing a weight for the prediction of that specialized model that is at least double the weight for the prediction of the base model. Otherwise, if no specialized models are determined to be suitable for ensembling in step 312, then ensembling module 210 returns the initial base model prediction as the final prediction, without determining the aforementioned weighting, without performing ensembling, and without generating a refinement of the initial base model prediction.

After step 314, the process of FIG. 3 ends at an end node 316.

In one embodiment, multiple distinct label groupings are determined and used to train multiple respective specialized models. For example, based on base model accuracy evaluation module 204 determining that a first label grouping for the sub-range 0.0 to 0.1 and a second label grouping for the sub-range 0.9 to 1.0 have unacceptable accuracies, specialized model training module 206 trains a first specialized model for the 0.0 to 0.1 sub-range and a second specialized model for the 0.9 to 1.0 sub-range. Subsequently, during inference time, if the base model generates a first prediction in the 0.0 to 0.1 sub-range, then ensembling module 210 ensembles the base model together with the first specialized model, and if the base model generates a second prediction in the 0.9 to 1.0 sub-range, then ensembling module 210 ensembles the base model together with the second specialized model.

In one embodiment, multiple label groupings can be defined recursively. For example, base model accuracy evaluation module 204 determines an unacceptable base model accuracy for a the sub-range 0.0 to 0.1, and specialized model training module 206 trains a first specialized model for the sub-range 0.0 to 0.1, but further evaluation by base model accuracy evaluation module 204 reveals that a smaller, recursively defined sub-range of 0.00 to 0.01 within the sub-range 0.0 to 0.1 still does not have an acceptable accuracy for base model predictions. Based on this further evaluation, specialized model training module 206 trains a second specialized model for the sub-range of 0.00 to 0.01. During inference and based on a prediction by the base model that is included in the smaller sub-range of 0.00 to 0.01, ensembling module 210 ensembles the base model, the first specialized model, and the second specialized model to generate a final prediction. In another embodiment, a first specialized model is trained for the sub-range 0.0 to 0.1, as discussed above, and an evaluation by a separate specialized model accuracy evaluation module (not shown in FIG. 2) reveals that the smaller, recursively defined sub-range of 0.00 to 0.01 does not have an acceptable accuracy for specialized model predictions. Based on the evaluation by the specialized model accuracy evaluation module, specialized model training module 206 trains a second specialized model for the sub-range of 0.00 to 0.01. During inference, based on a prediction by the base model that is included in the sub-range of 0.0 to 0.1, and based on a further prediction by the first specialized model that is in the recursive sub-range of 0.00 to 0.01, an additional prediction is generated by the second specialized model. Ensembling module 210 ensembles the predictions from the first specialized model and the second specialized model to generate an intermediate prediction, which is then ensembled with the base model prediction to generate a final prediction.

In one embodiment, step 306 includes base model accuracy evaluation module 204 identifying a set of label groupings whose respective accuracies do not satisfy the end user-defined criteria specifying a relative closeness or an exact closeness of base model predictions to expected values, where the criteria are based on end user requirements, step 308 includes specialized training module 206 training, using reduced training sets, respective specialized models for the label groupings included in the identified set of label groupings, step 312 includes base model prediction analysis module 208 selecting, during inference and using a clustering model, one or more specialized models from the specialized model(s) that were preserved in step 310, and step 314 includes ensembling module 210 generating a prediction from an ensembling using the base model and the selected one or more specialized models. In one embodiment, step 314 includes ensembling module 210 determining, using the aforementioned clustering model, ensemble weighting for the ensembling using the base model and the aforementioned selected one or more specialized models, where the ensemble weighting is based on how close a base model prediction is to one or more label groupings for which the selected one or more specialized models are trained.

In one embodiment, label grouping determination module 202 in step 302 applies grouping-specific hyperparameters to a given label grouping. In one embodiment, label grouping determination module 202 determines in step 302 that a given label grouping included in the label groupings exclusively includes positive values, where each positive value is less than a predetermined threshold value. Based on the given label grouping exclusively including positive values less than the predetermined threshold value, label grouping determination module 202 applies a label log transformation to the given label grouping. The transformed labels resulting from the application of the label log transformation are used only by a corresponding specialized model that is trained for the given label grouping.

In one embodiment, label grouping determination module 202 in step 302 applies a grouping-specific optimization technique to a given label grouping. As one example of a grouping-specific optimization technique being applied, label grouping determination module 202 determines in step 302 that a given label grouping included in the label grouping(s) determined in step 306 exclusively includes values that exceed a predetermined threshold value. Based on the given label grouping exclusively including values that exceed the predetermined threshold value, label grouping determination module 202 applies a mean squared error loss function to the given label grouping. The optimization technique that applies the mean squared error loss function is for usage only by the specialized model that is trained for the given label grouping. This optimization technique cannot be applied to the base model, since the technique is sub-range specific and the base model must cover the entire output range.

As another example of a grouping-specific optimization technique being applied, label grouping determination module 202 determines in step 302 that a given label grouping included in the label grouping(s) determined in step 306 exclusively includes values that are less than a predetermined threshold value. Based on the given label grouping exclusively including values that are less than the predetermined threshold value, label grouping determination module 202 applies a cross-entropy loss function to the given label grouping. The optimization technique that applies the cross-entropy loss function is for usage only by the specialized model that is trained for the given label grouping. Similar to the discussion above relative to the mean squared error loss function, the optimization technique that applies the cross-entropy loss function cannot be applied to the base model.

In one embodiment, ensembling by ensembling module 210 in step 310 includes providing input features and a corresponding output prediction of the base model as an additional input parameter to a given specialized model.

FIG. 4 is a block diagram of components in a training part of a system that performs the operations in the flowchart of FIG. 3 that occur during training time, in accordance with embodiments of the present invention. System 400 includes a training set 402, a label grouping tool 404, a base model 406, an accuracy evaluation tool 408, a specialized model training system 410, an ensemble system 412, a reduced error detection tool 414, and a preserved specialized model repository 416.

Label grouping tool 404 and base model 406 receive data from training set 402. Based on the received data, base model 406 is trained and label grouping tool 404 identifies an output range and determines label groupings as subsets of the output range of the base model. In one embodiment, the subsets are mutually exclusive and collectively exhaustive with respect to the entirety of the output range. In another embodiment, the subsets associated with the label groupings are included in a first collection of subsets and a second collection of subsets, where the subsets in the first collection consist of non-overlapping subsets that sub-divide the entirety of the output range, and where each of the subset(s) in the second collection consist of sub-divisions of another subset (e.g., a subset in the second collection consists of sub-divisions of a subset in the first collection). Label grouping tool 404 sends the label groupings to base model 406.

Base model 406 uses samples received from training set 402 to generate predictions and base model 406 sends the label groupings and generated predictions to accuracy evaluation tool 408. Accuracy evaluation tool 408 evaluates the accuracies of the generated predictions and determine which (if any) label groupings have an accuracy that does not satisfy end user-defined criteria specifying a relative closeness or an exact closeness of base model predictions to expected values, where the criteria are based on end user requirements (i.e., which label groupings, if any, have an unacceptable accuracy).

Using label groupings received from label grouping tool 404 and the evaluated accuracies received from accuracy evaluation tool 408, specialized model training system 410 trains specialized model(s) only for label grouping(s) that were determined to have unacceptable accuracy by accuracy evaluation tool 408. Specialized model training system 410 trains a given specialized model using a training set that includes samples whose output label is included in the targeted label grouping.

Ensemble system 412 receives the accuracy evaluations from accuracy evaluation tool 408 and the specialized model(s) trained by specialized model training system 410. Ensemble system 412 ensembles the base model 406 and the specialized model(s) trained by specialized model training system 410 to generate predictions. Ensemble system 412 sends the generated predictions to reduced error detection tool 414, which determines whether predictions in a given label grouping associated with a given specialized model have an accuracy that is an improvement over the accuracy determined by accuracy evaluation tool 408 for the same label grouping (i.e., whether the predictions generated by ensemble system 412 have reduced error). If reduced error detection tool 414 detects a reduced error associated with the label groupings of a given specialized model, then reduced error detection tool 414 preserves the given specialized model by storing the given specialized model in preserved specialized model repository 416.

FIG. 5 is a block diagram of components in an inference part a system that performs the operations in the flowchart of FIG. 3 that occur during inference time, in accordance with embodiments of the present invention. System 500 includes inference inputs 502, a base model 504, a prediction analysis tool 506, specialized model(s) 508, an ensemble system 510, a returned ensembled prediction 512 and a returned base model prediction 514.

Base model 504 receives inference inputs 502 and generates base model predictions based on the inference inputs 502. Base model 504 sends the base model predictions to prediction analysis tool 506, which compares each base model prediction to the label groupings determined by label grouping tool 404 to determine which, if any, of the specialized models trained by specialized training system 410 and stored in preserved specialized model repository 416 are suitable for ensembling with base model 504 (i.e., for a given base model prediction, determine which, if any, of the specialized models in preserved specialized model repository 416 are trained for label grouping(s) that specify a range that includes the given base model prediction). In another embodiment, prediction analysis tool uses a separate cluster model to determine which of the specialized models in preserved specialized model repository 416 are suitable for the aforementioned ensembling, and to determine respective ensemble weighting.

In one embodiment, prediction analysis tool 506 determines that one or more specialized models (i.e., specialized model(s) 508) are suitable for ensembling with base model 504 based on the comparison of a given base model prediction to the label groupings, as described above. System 500 retrieves specialized model(s) 508 from preserved specialized model repository 416. Ensemble system 510 dynamically determines a weighting for an ensembling based on measure(s) of closeness of the given base model prediction to label grouping(s) for which specialized model(s) 508 are trained. Further, ensemble system 510 performs the ensembling using the base model 504, the specialized model(s) 508, and the weighting. Still further, ensemble system 510 uses the ensembling to generate returned ensembled prediction 512 (i.e., refines the given base model prediction to generate and return a refined final prediction as the output of the ensembling).

Alternatively, if prediction analysis tool 506 determines that no specialized models exist in preserved specialized model repository 416 that are suitable for ensembling with base model 504 for a given base model prediction, then prediction analysis tool 506 returns the given base model prediction as returned base model prediction 514, without using a specialized model.

In one embodiment, an entire system for prediction-guided ensembling for machine learning models that performs the operations in the flowchart of FIG. 3 includes system 400 in FIG. 4 and system 500 in FIG. 5, where base model 504 in FIG. 5 and base model 406 in FIG. 4 are the same base model, and ensemble system 510 in FIG. 5 and ensemble system 412 in FIG. 4 are the same ensemble system.

### Empirical Results for a Regression Model

Using an AI Query Optimizer and without using the method and system disclosed herein, 72.9% of validation queries are predicted accurately. 5.7% of queries, however, are mis-predicted by >2×, with a mean mis-prediction factor of 4.9×. By using the method and system disclosed herein, a secondary model (i.e., specialized model) is trained on the regression range [0.0 . . . 0.1] and the total training time is increased by ˜70% (i.e., less than a 2× increase). Furthermore, 73.9% of the validation queries are predicted accurately by using the method and system disclosed herein, where 2.9% of queries are mis-predicted by >2× (i.e., an improvement of approximately 2×), with a mean mis-prediction factor of 3.0×.

The following empirical results are with respect to the most problematic range (i.e., [0.00 . . . 0.01]). Without using the method and system disclosed herein, only 7.3% of validation queries are predicted accurately, and 56.7% of queries are mis-predicted by >2×, with a mean mis-prediction factor of 5.3×. By using the method and system disclosed herein, 18.1% of validation queries are predicted accurately for an improvement of approximately 2.5×, and only 21.4% of queries are mis-predicted by >2× (i.e., an improvement of approximately 2.6×), with a mean mis-prediction factor of 3.2×.

The descriptions of the various embodiments of the present invention have been presented herein for purposes of illustration but are not intended to be exhaustive or limited to the embodiments disclosed. Many modifications and variations will be apparent to those or ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
determining label groupings within an output range of a base machine learning model;
evaluating accuracies of the base model across the label groupings;
identifying one or more of the label groupings whose respective evaluated accuracy does not satisfy end user-defined criteria specifying a closeness of predictions by the base model to expected values;
training, using a reduced training set, a specialized machine learning model for a given label grouping included in the identified one or more label groupings, wherein a majority of samples of the reduced training set are from the given label grouping;
determining, during inference, that an initial prediction by the base model is within an output range specified by the given label grouping;
determining a weighting for an ensembling using the base model and the specialized model; and
refining, using the ensembling, the initial prediction to generate a final prediction.

2. The method of claim 1, further comprising:
determining a first label grouping and a second label grouping, wherein the determining the first and second label groupings is included in the determining the label groupings;
evaluating a first accuracy of the base model across the first label grouping and a second accuracy of the base model across the second label grouping, wherein the evaluating the first and second accuracies is included in the evaluating the accuracies;
identifying a first label grouping whose evaluated first accuracy does not satisfy the end user-defined criteria and identifying a second label grouping whose evaluated second accuracy does not satisfy the end user-defined criteria;
training, using a first training set, a first specialized model for the first label grouping, wherein the first training set includes first samples whose output labels are included in the first label grouping;
training, using a second training set, a second specialized model for the second label grouping, wherein the second training set includes second samples whose output labels are included in the second label grouping;
determining that a first prediction accuracy for a first prediction generated by a first ensembling that includes the base model and the first specialized model is greater than the evaluated first accuracy;
determining that a second prediction accuracy for a second prediction generated by a second ensembling that includes the base model and the second specialized model is less than the evaluated second accuracy;
in response to the determining that the first prediction accuracy is greater than the evaluated first accuracy, adding the first specialized model to a set of specialized models for a usage during inference; and
in response to the determining that the second prediction accuracy is less than the evaluated second accuracy, preventing the second specialized model from being included in the set of specialized models for the usage during inference.

3. The method of claim 1, further comprising:
identifying a set of label groupings whose respective accuracies do not satisfy the end user-defined criteria;
training, using reduced training sets, respective specialized models for the label groupings included in the set of label groupings;
selecting, during inference and using a clustering model, one or more specialized models included in the trained specialized models; and
generating a prediction from an ensembling using the base model and the selected one or more specialized models.

4. The method of claim 3, further comprising:
determining, using the clustering model, ensemble weighting for the ensembling using the base model and the selected one or more specialized models, wherein the ensemble weighting is based on how close the generated prediction is to one or more label groupings for which the one or more specialized models are trained.

5. The method of claim 1, further comprising:
determining that the given label grouping exclusively includes positive values, where each positive value is less than a predetermined threshold value; and
based on the given label grouping exclusively including the positive values less than the predetermined threshold value, applying a label log transformation to the given label grouping.

6. The method of claim 1, further comprising:
determining a label grouping included in the one or more label groupings exclusively includes values that exceed a predetermined threshold value; and
based on the label grouping exclusively including the values that exceed the predetermined threshold value, applying a mean squared error loss function to the label grouping.

7. The method of claim 1, further comprising:
determining a label grouping included in the one or more label groupings exclusively includes values that are less than a predetermined threshold value; and
based on the label grouping exclusively including the values that are less than the predetermined threshold value, applying a cross-entropy loss function to the label grouping.

8. The method of claim 1, further comprising providing an output prediction of the base model as an additional input parameter to the specialized model.

9. A computer system comprising:
a processor set;
one or more computer-readable storage media; and
program instructions stored on the one or more computer-readable storage media to cause the processor set to perform computer operations comprising:
determining label groupings within an output range of a base machine learning model;
evaluating accuracies of the base model across the label groupings;
identifying one or more of the label groupings whose respective evaluated accuracy does not satisfy end user-defined criteria specifying a closeness of predictions by the base model to expected values;
training, using a reduced training set, a specialized machine learning model for a given label grouping included in the identified one or more label groupings, wherein a majority of samples of the reduced training set are from the given label grouping;
determining, during inference, that an initial prediction by the base model is within an output range specified by the given label grouping;
determining a weighting for an ensembling using the base model and the specialized model; and
refining, using the ensembling, the initial prediction to generate a final prediction.

10. The computer system of claim 9, wherein the computer operations further comprise:
determining a first label grouping and a second label grouping, wherein the determining the first and second label groupings is included in the determining the label groupings;
evaluating a first accuracy of the base model across the first label grouping and a second accuracy of the base model across the second label grouping, wherein the evaluating the first and second accuracies is included in the evaluating the accuracies;
identifying a first label grouping whose evaluated first accuracy does not satisfy the end user-defined criteria and identifying a second label grouping whose evaluated second accuracy does not satisfy the end user-defined criteria;
training, using a first training set, a first specialized model for the first label grouping, wherein the first training set includes first samples whose output labels are included in the first label grouping;
training, using a second training set, a second specialized model for the second label grouping, wherein the second training set includes second samples whose output labels are included in the second label grouping;
determining that a first prediction accuracy for a first prediction generated by a first ensembling that includes the base model and the first specialized model is greater than the evaluated first accuracy;
determining that a second prediction accuracy for a second prediction generated by a second ensembling that includes the base model and the second specialized model is less than the evaluated second accuracy;
in response to the determining that the first prediction accuracy is greater than the evaluated first accuracy, adding the first specialized model to a set of specialized models for a usage during inference; and
in response to the determining that the second prediction accuracy is less than the evaluated second accuracy, preventing the second specialized model from being included in the set of specialized models for the usage during inference.

11. The computer system of claim 9, wherein the computer operations further comprise:
identifying a set of label groupings whose respective accuracies do not satisfy the end user-defined criteria;
training, using reduced training sets, respective specialized models for the label groupings included in the set of label groupings;
selecting, during inference and using a clustering model, one or more specialized models included in the trained specialized models; and
generating a prediction from an ensembling using the base model and the selected one or more specialized models.

12. The computer system of claim 11, wherein the computer operations further comprise:
determining, using the clustering model, ensemble weighting for the ensembling using the base model and the selected one or more specialized models, wherein the ensemble weighting is based on how close the generated prediction is to one or more label groupings for which the one or more specialized models are trained.

13. The computer system of claim 9, wherein the computer operations further comprise:
determining that the given label grouping exclusively includes positive values, where each positive value is less than a predetermined threshold value; and
based on the given label grouping exclusively including the positive values less than the predetermined threshold value, applying a label log transformation to the given label grouping.

14. The computer system of claim 9, wherein the computer operations further comprise:
determining a label grouping included in the one or more label groupings exclusively includes values that exceed a predetermined threshold value; and
based on the label grouping exclusively including the values that exceed the predetermined threshold value, applying a mean squared error loss function to the label grouping.

15. A computer program product comprising:
one or more computer-readable storage media; and
program instructions stored on the one or more computer-readable storage media to perform computer operations comprising:
determining label groupings within an output range of a base machine learning model;
evaluating accuracies of the base model across the label groupings;
identifying one or more of the label groupings whose respective evaluated accuracy does not satisfy end user-defined criteria specifying a closeness of predictions by the base model to expected values;
training, using a reduced training set, a specialized machine learning model for a given label grouping included in the identified one or more label groupings, wherein a majority of samples of the reduced training set are from the given label grouping;
determining, during inference, that an initial prediction by the base model is within an output range specified by the given label grouping;
determining a weighting for an ensembling using the base model and the specialized model; and
refining, using the ensembling, the initial prediction to generate a final prediction.

16. The computer program product of claim 15, wherein the computer operations further comprise:
determining a first label grouping and a second label grouping, wherein the determining the first and second label groupings is included in the determining the label groupings;
evaluating a first accuracy of the base model across the first label grouping and a second accuracy of the base model across the second label grouping, wherein the evaluating the first and second accuracies is included in the evaluating the accuracies;
identifying a first label grouping whose evaluated first accuracy does not satisfy the end user-defined criteria and identifying a second label grouping whose evaluated second accuracy does not satisfy the end user-defined criteria;
training, using a first training set, a first specialized model for the first label grouping, wherein the first training set includes first samples whose output labels are included in the first label grouping;
training, using a second training set, a second specialized model for the second label grouping, wherein the second training set includes second samples whose output labels are included in the second label grouping;
determining that a first prediction accuracy for a first prediction generated by a first ensembling that includes the base model and the first specialized model is greater than the evaluated first accuracy;
determining that a second prediction accuracy for a second prediction generated by a second ensembling that includes the base model and the second specialized model is less than the evaluated second accuracy;
in response to the determining that the first prediction accuracy is greater than the evaluated first accuracy, adding the first specialized model to a set of specialized models for a usage during inference; and
in response to the determining that the second prediction accuracy is less than the evaluated second accuracy, preventing the second specialized model from being included in the set of specialized models for the usage during inference.

17. The computer program product of claim 15, wherein the computer operations further comprise:
identifying a set of label groupings whose respective accuracies do not satisfy the end user-defined criteria;
training, using reduced training sets, respective specialized models for the label groupings included in the set of label groupings;
selecting, during inference and using a clustering model, one or more specialized models included in the trained specialized models; and
generating a prediction from an ensembling using the base model and the selected one or more specialized models.

18. The computer program product of claim 17, wherein the computer operations further comprise:
determining, using the clustering model, ensemble weighting for the ensembling using the base model and the selected one or more specialized models, wherein the ensemble weighting is based on how close the generated prediction is to one or more label groupings for which the one or more specialized models are trained.

19. The computer program product of claim 15, wherein the computer operations further comprise:
determining that the given label grouping exclusively includes positive values, where each positive value is less than a predetermined threshold value; and
based on the given label grouping exclusively including the positive values less than the predetermined threshold value, applying a label log transformation to the given label grouping.

20. The computer program product of claim 15, wherein the computer operations further comprise:
determining a label grouping included in the one or more label groupings exclusively includes values that exceed a predetermined threshold value; and
based on the label grouping exclusively including the values that exceed the predetermined threshold value, applying a mean squared error loss function to the label grouping.
